(19) United States
(12) Patent Application Publication
(10) Pub. No.: US 2009/0158058 A1
(43) Pub. Date: Jun. 18, 2009

(54) ASSEMBLY OF A POWER SUPPLY TO A DATA ACCESS DEVICE

(76) Inventor: Hugo Lin, Taipei Hsien (TW)

Correspondence Address: Hugo Lin, 235 Chung - Ho, Box 8-24, Taipei, TW

(21) Appl. No.: 11/959,446

(22) Filed: Dec. 18, 2007

(51) Int. Cl. G06F 1/26

(52) U.S. Cl. 713/300

(57) ABSTRACT

An assembly of a power supply to a data access device inside which a 3.5-inch hard disk and a circuit are provided. The hard disk is electrically connected to a signal and power conversion unit to obtain a required voltage and signal supplied by the signal and power conversion unit. Two connection terminals arranged on the signal and power conversion unit are respectively may transmit a signal and meanwhile carry a first voltage to supply power to a circuit and its electronic parts and may receive only a second voltage or convert the second voltage into a third voltage. Alternatively, dual sets of second and third voltage are optionally received as the power supplied to the 3.5-inch hard disk and the circuit and its electronic parts for a solution to a dual-channel multi-power and signal transmission.

### BACKGROUND OF THE INVENTION

1. Field of the Invention

This invention relates to an assembly of a power supply to a data access device and particularly to an assembly of a power supply to a 3.5-inch portable hard disk or namely data access device that is provided with a signal and power conversion unit (PCU).

2. Description of Related Art

A 3.5-inch external hard disk must work with an external power supply mainly because the 3.5-inch hard disk use two sets of power supplies of which two sets of voltage are +12V and +5V that is provided for a motor and a PCB in the hard disk to operate. Thus, if often taking a laptop PC and the external hard disk to stay out, s/he needs an external power cord for the 3.5-inch external hard disk, which is not a good choice.

Refer to FIG. 1 illustrating a conventional 3.5-inch external hard disk drive and a manner of connecting the hard disk drive to a host PC, briefly named an external hard disk. Through an AC power adapter 10 and a transformer 12, a converted voltage passes from a power cable 14 connected to an electric power connection terminal 16a for the required power supply to a hard disk motor to operate at a high speed. The power supply is generally provided for a single set (+12V) or a dual set (+12V and +5V). Besides, a signal connection terminal 16b is provided on the external hard disk drive 1, in which signal connection terminal 16b is provided for bidirectional transmission of a signal between the PC host 20 and the hard disk drive 1, and a signal cable in the signal connection terminal 16b, such as a USB 2.0 cable, is supplied with a +5V power supply to a PCB and electronic parts that are arranged in the external hard disk drive 1. Thus, the 3.5-inch external hard disk drive 1 needs two sets of power supplies (+1.2V and +5V) to drive the hard disk (not shown), the internal electronic parts, and the PCB.

In the manner, the power adapter provided with the transformer, and the connection cables must be attached in the device when being sold, the production cost is higher, and the circuit is complicated. Further, if no electrical outlet is not provided in an environment, the 3.5-inch external hard disk drive cannot be used, which is inconvenient. Next, the power cable of transformer is independent of the 3.5-inch external hard disk drive, so it cannot be connected or cut off while the PC is turned ON or OFF and then must work with a switch to supply or cut the power, and in case of frequent switching ON and OFF, its service life is reduced, thereby inconvenience being brought as described above.

Consequently, because of the technical defects of described above, the applicant keeps on carving unflaggingly through wholehearted experience and research to develop the present invention, which can effectively improve the defects described above.

### SUMMARY OF THE INVENTION

It is an objective of this invention to provide a simple assembly of a power supply to a data access device. A conventional transformer and related transmission cable are abridged, and multiple power supplies are supplied signals are transmitted directly by a host PC.

It is a further objective of this invention to enhance an application of the 3.5-inch external hard disk so as to drive the external hard disk to be turned ON or OFF synchronously when the host PC is ON or OFF by using a connection terminal of a signal conversion device.

To achieve above object, the present invention provides an assembly of a power supply to a data access device, supplying a required signal and power to the data access device through a host PC, comprising: a transmission interface arranged in the host PC and provided with a signal terminal and a power terminal that may respectively receive a signal and at least one power supply supplied by the host PC; a first connection cable connected to the signal terminal of transmission interface; a second connection cable connected to the power terminal of transmission interface; and a 3.5-inch data access device provided with a hard disk, a hard disk motor, a circuit, and a signal and power conversion unit; the signal and power conversion unit being provided with a first connection terminal and a second connection terminal; the first connection terminal being connected to the first connection cable to receive data and power transmitted by the signal and power conversion unit; the second connection terminal being connected to the second connection cable to obtain power supplied by the signal and power conversion unit.

The signal terminal of transmission interface is electrically connected to a motherboard in the host PC and the power terminal is electrically connected to the power supply in the host PC to supply the required power to the data access device. The first connection terminal of the signal and power conversion unit may receive data and first voltage carried by the first connection cable to supply the power to the circuit of data access device. The second connection terminal of the signal and power conversion unit may receive second voltage carried by the second connection cable to supply the power to the hard disk of data access device for driving. The data access device is further provided with a conversion circuit through which the second voltage is dripped to a third voltage equal to the first voltage that is supplied to the circuit and its electronic parts that are arranged in the external hard disk, thereby the first connection cable simply serving for data supply. The second connection terminal of the signal and power conversion unit may receive dual sets of second and third voltage that are carried by the second connection cable to supply the power to the hard disk of data access device and the circuit and its electronic parts for driving.

The transmission interface may be an I/O interface installed in the host PC, and a transmitted first voltage and a signal that are connected to the signal terminal are respectively a +5V voltage and a data signal. A transmitted second voltage connected to the power supply terminal is a +12V voltage. The second voltage may be a third voltage dropped into +5V by a conversion circuit; alternatively, paired sets of second and third voltage are optionally received.

Generally, the transmission of host PC and the connection terminal of signal and electric power conversion device may be based on a protocol of loading of both the power supply and the signal, such as a standard set by the USB association.

Virtues collocated with those of the prior arts are described below.
1. An issue on the independent power supply to the external data access device (the 3.5-inch hard disk) is effectively solved for simplification of the conventional connection structure.
2. The power supplied by the transformer is not needed in this invention but supplied directly by an existing +12V power supply provided in the host.
3. A single set of second voltage (+12V) may be received, or paired sets of second voltage (+12V) and third voltage (+5V) may be optionally received, which is more convenient.

### BRIEF DESCRIPTION OF THE DRAWINGS

FIG. 1 is a schematic view illustrating a service condition of a conventional external data access device;

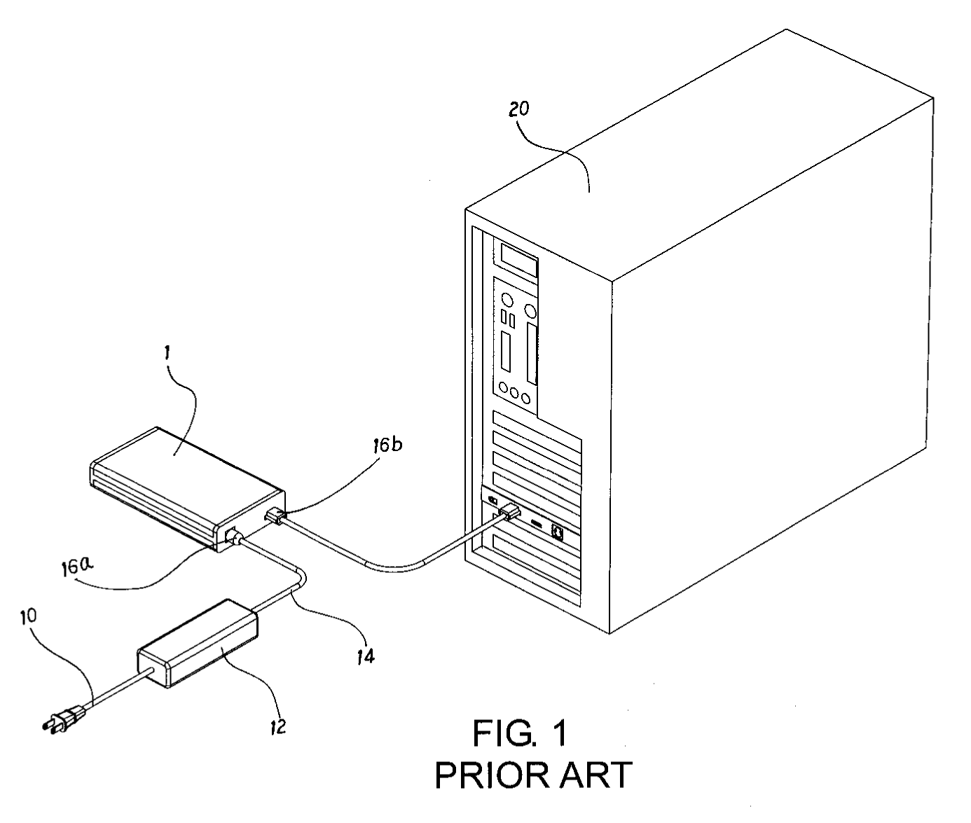

FIG. 2 is an exploded view of an assembly according to this invention that works with a PC transmission interface;

FIG. 3 is an assembly drawing of the assembly according to this invention that works with the PC transmission interface;

FIG. 4 is a schematic view illustrating the fitting of the PC transmission interface into a host;

FIG. 5 is a block diagram of an assembly of a power supply according to this invention;

FIG. 6 is an exploded view of the assembly working with the PC transmission interface in an embodiment of this invention; and

FIG. 7 is an exploded view of the assembly working with the PC transmission interface in the other embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

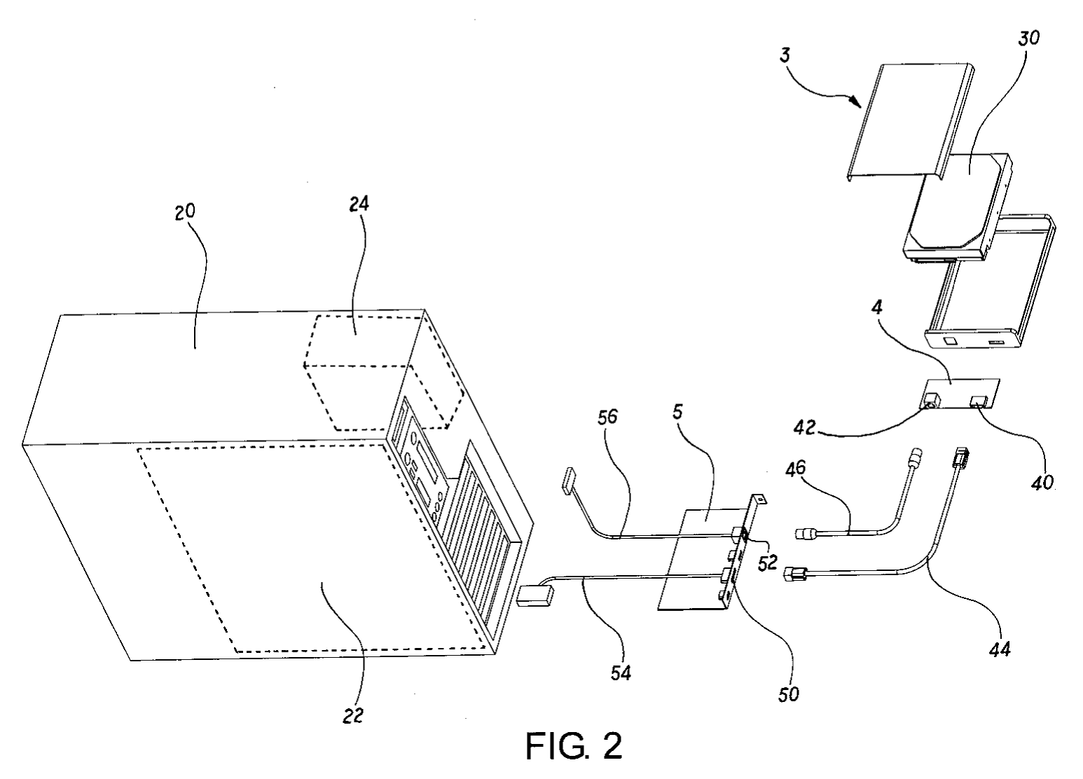

With reference to FIG. 2 illustrating an assembly of a power supply to a data access device according to this invention, the data access device is named a 3.5-inch external hard disk drive 3 inside which a 3.5-inch hard disk 30 and its application circuit are provided; a drive motor of the hard disk 30 supply a power through an electric connection signal and a power conversion unit 4, and the 3.5-inch hard disk 30 and the signal and power conversion unit 4 are integrated into a case. The signal conversion device 4 is provided with a first connection terminal 40 and a second connection terminal 42 that are used to receive external data and power source transmitted. For example, the first connection terminal 40 may connect and receive the first connection cable (data cable) 44 carrying data or/and a first voltage, and through the first connection cable 44, a power, such as +5V, is supplied to the signal and electric conversion unit 4 and its application circuit inside; the second connection terminal 42 may connect and receive the second connection cable (power cable) 46 carrying the second voltage, and through the second connection cable 46, a power of +12V is supplied to a hardware motor for driving.

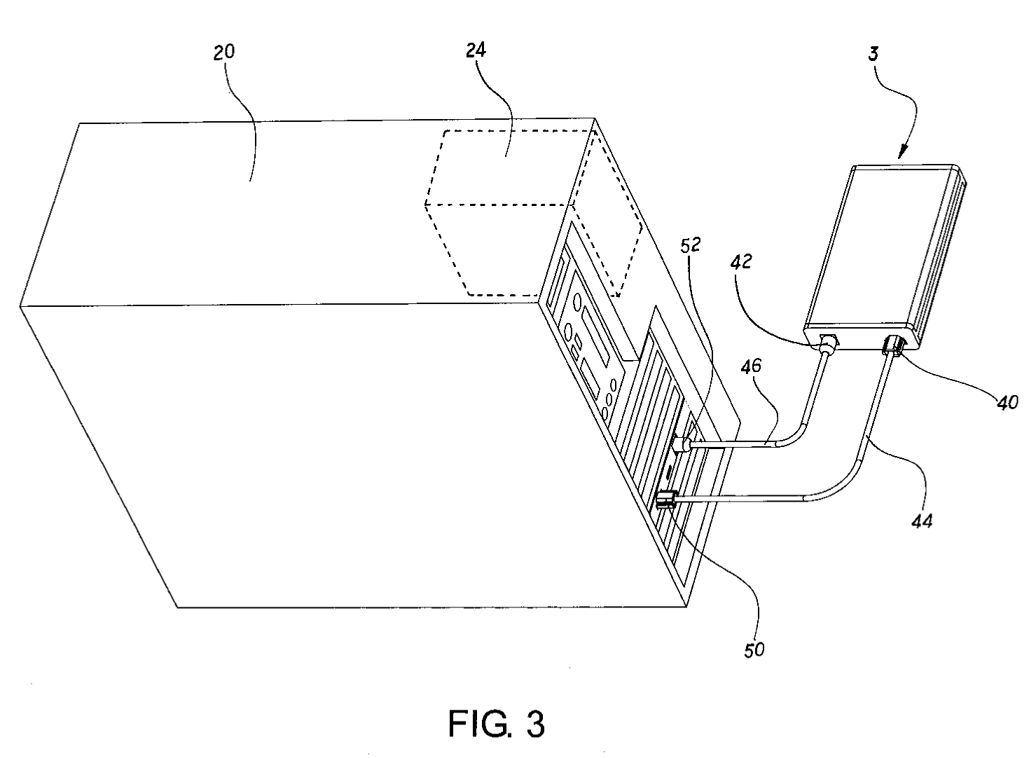

Front ends of the connection cables 44 and 46 are connected to a transmission interface 5, being corresponding to the hard disk drive 3. The transmission interface 5 is provided with a signal terminal 50 and a power terminal 52, in which the signal terminal 50 is electrically connected to the first connection terminal 40 of the signal and power conversion unit 4 through the first connection cable (data cable) 44 and the power terminal 52 is electrically connected to the second connection terminal 42 of the signal and power conversion unit 4 through the second connection cable (power cable) 46. The signal terminal 50 and power terminal 52 of the transmission interface 5, which are provided in another specification and corresponding to inner wires 54 and 56 of the first connection cable 44 and second connection cable 46, are electrically connected to a motherboard 22 and the power supply 24 which are arranged in the host PC 20. The motherboard 22 may supply the +5V voltage or transmit a pure signal without the +5V voltage; the power supply 24 may supply the +12V voltage. Thus, the complete assembly of power supply to the data access device according to this invention is illustrated as shown in FIG. 3.

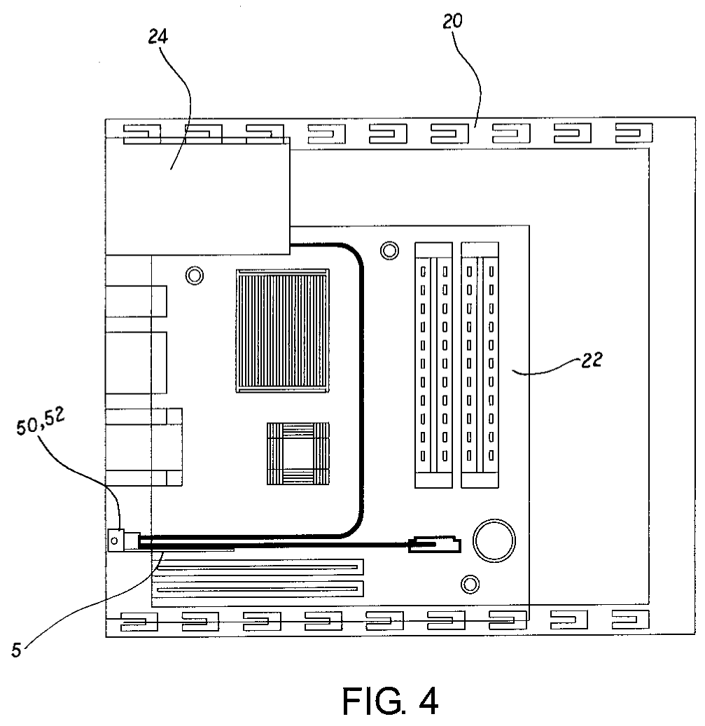

With reference to FIG. 4, the transmission interface 5 may be arranged in a slot of the host PC 20. The signal terminal 50 and power terminal 52 of the transmission interface 5 are electrically connected to the motherboard 22 and power supply 24 in the PC, respectively. In the manner of connection, the power or data of the external hard disk drive is ON or OFF synchronously when the host PC 20 is ON or OFF, thereby the possibility of sequential turn ON and OFF as imperfection being improved.

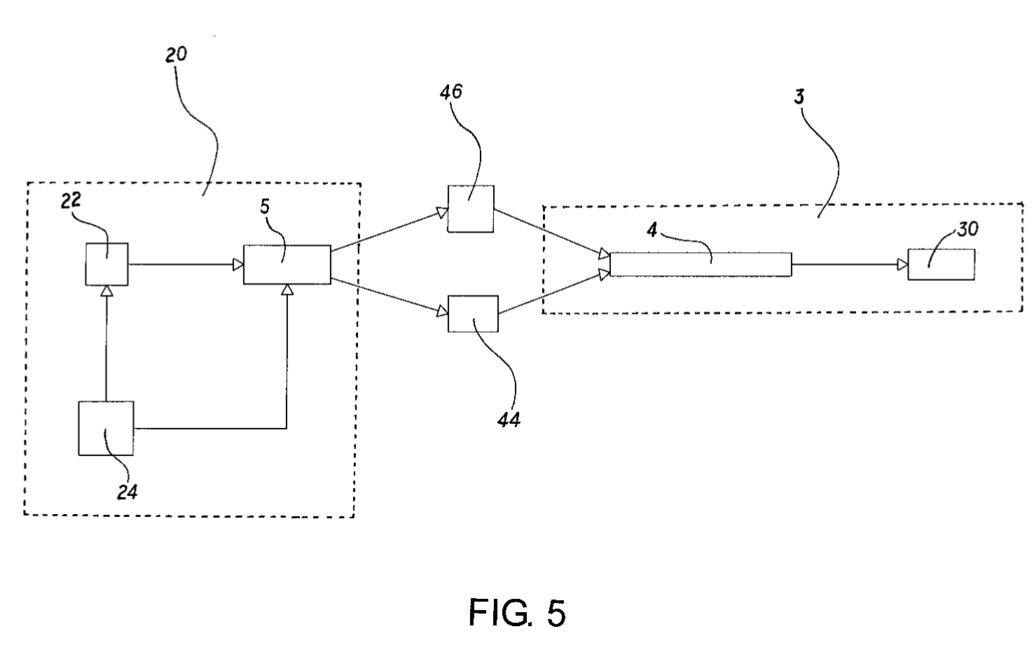

In order to describe the application of the external hard disk drive according to this invention in more detail, a block diagram of the power supply assembly is illustrated for reference, as shown in FIG. 5. The host PC 20 and the external hard disk drive (data access device) 3 electrically connect the signal from the transmission interface 5 and the signal and power conversion unit 4 through the first connection cable (data cable) 44 to the first connection terminal of the signal and power conversion unit 4, and the power through the second connection cable (power cable) 46 to the second connection terminal of the signal and power conversion unit 4. Thus, the first voltage (+5V) required by the external hard disk drive 3 and the second voltage (+12V) required by the hard disk motor may be obtained from the host PC 20 by means of a dual-channel transmission between the motherboard 22 and the power supply 24, so the power cable provided with the transformer, and the connection cables are not required.

Further, the assembly may be used to separately transmit the data and the power. On one hand, the voltage supplied by the power supply is alone transmitted through the second connection cable (power cable); the defined second voltage may be directly supplied to the hard disk motor, and the +12V second voltage may be dropped by a conversion circuit to a third voltage of +5V equal to the first voltage and supplied to the circuit and electronic parts in the external hard disk, and the first connection cable (data cable) 44 is simply used for data transmission.

On the other hand, in this invention, optionally through the second connection cable 46 for the second connection terminal 42, the sets of second voltage (+12V) and third voltage (+5V) obtained from the connection cable 56 inside the transmission interface 5 may be received and supplied to the 3.5-inch hard disk 30 to work and to the circuit and its electronic parts, and the first connection cable 44 is simply used for data transmission.

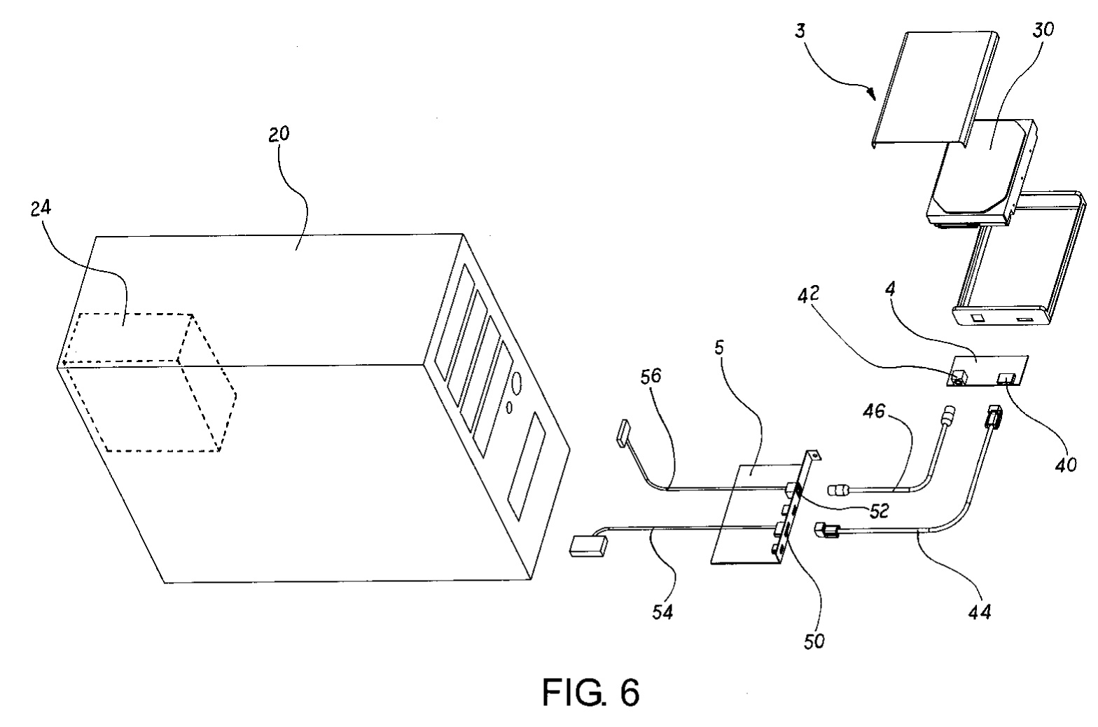

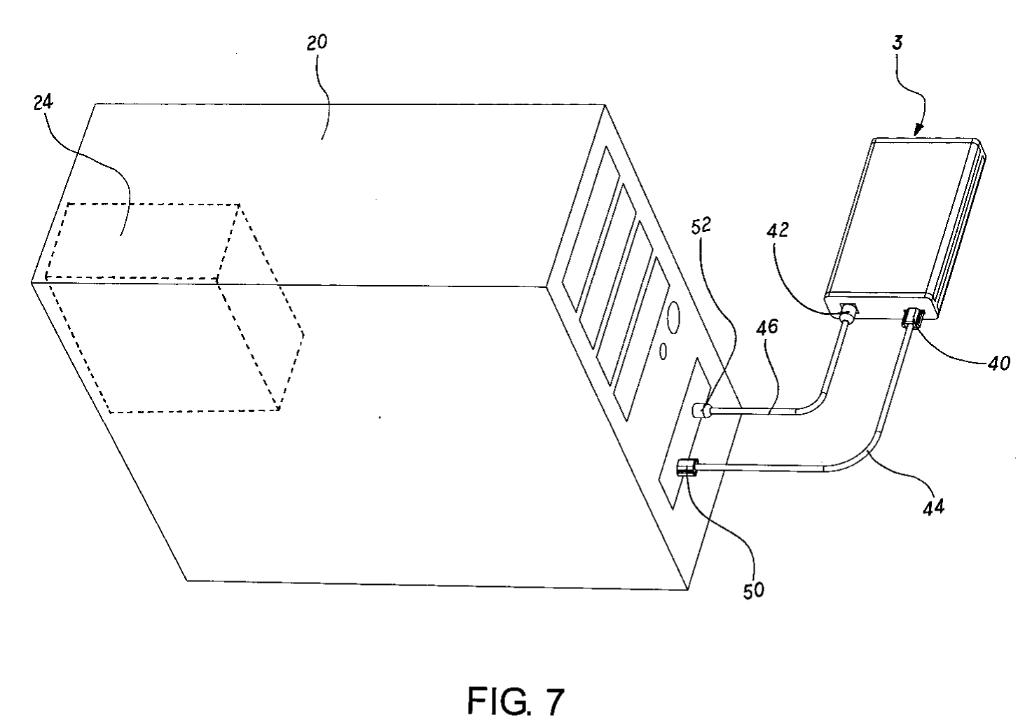

Next, with reference to FIGS. 6 and 7 illustrating exploded and combined assemblies working with the PC transmission interface in another embodiment of this invention, the transmission interface 5 is arranged in a front slot of the host PC 20 and likewise the signal terminal 50 and power terminal 52 of the transmission interface 5 are electrically connected to the host PC 22 and the power supply 24, respectively, through the connection cable (not shown), as shown in FIG. 3.

The 3.5-inch hard disk 30 and the signal and power conversion unit 4 are provided in the external hard disk drive 3, as integrated together. The signal and power conversion unit 4 is provided with the connection terminal 40 and the second connection terminal 42; likewise, the first connection terminal 40 is connected to the first connection cable (data cable) 44 carrying the data or/and the first voltage, while the second connection terminal 42 may be connected to the second connection cable (power cable) 46 carrying only the second voltage or optionally receiving dual sets of second and third voltage to supply the required power to the 3.5-inch hard disk and the circuit and its electronic parts.

In the manner mentioned above, arrangement in the front or back slot may be made corresponding to the host PC 20 for the convenience of use.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An assembly of a power supply to a data access device, supplying a required signal and power to the data access device through a host PC, comprising:
a transmission interface arranged in the host PC and provided with a signal terminal and a power terminal that may respectively receive a signal and at least one power supply supplied by the host PC;
a first connection cable connected to the signal terminal of transmission interface;
a second connection cable connected to the power terminal of transmission interface; and
a 3.5-inch data access device provided with a hard disk, a hard disk motor, a circuit, and a signal and power conversion unit; the signal and power conversion unit being provided with a first connection terminal and a second connection terminal; the first connection terminal being connected to the first connection cable to receive data and power transmitted by the signal and power conversion unit; the second connection terminal being connected to the second connection cable to obtain power supplied by the signal and power conversion unit.

2. The assembly of power supply to the data access device according to claim 1, wherein the signal terminal of transmission interface is electrically connected to a motherboard in the host PC and the power terminal is electrically connected to the power supply in the host PC to supply the required power to the data access device.

3. The assembly of power supply to the data access device according to claim 1, wherein the first connection terminal of the signal and power conversion unit may receive data and first voltage carried by the first connection cable to supply the power to the circuit of data access device.

4. The assembly of power supply to the data access device according to claim 1, wherein the second connection terminal of the signal and power conversion unit may receive second voltage carried by the second connection cable to supply the power to the hard disk of data access device for driving.

5. The assembly of power supply to the data access device according to claim 1, wherein the data access device is further provided with a conversion circuit through which the second voltage is dripped to a third voltage equal to the first voltage that is supplied to the circuit and its electronic parts that are arranged in the external hard disk, thereby the first connection cable simply serving for data supply.

6. The assembly of power supply to the data access device according to claim 1, wherein the second connection terminal of the signal and power conversion unit may receive dual sets of second and third voltage that are carried by the second connection cable to supply the power to the hard disk of data access device and the circuit and its electronic parts for driving.
